(19) United States
(12) Patent Application Publication
(10) Pub. No.: US 2011/0193677 A1
(43) Pub. Date: Aug. 11, 2011

(54) BASE STATION, SENSOR NETWORK SYSTEM INCLUDING THE SAME, AND METHOD OF DETERMINING SECURITY THRESHOLD FOR SENSOR NETWORK SYSTEM

(75) Inventors: CHO TAE HO, Gunpo-si (KR); Choi Hyeon Myeong, Suwon-si (KR)

(73) Assignee: SUNGKYUNKWAN UNIVERSITY FOUNDATION FOR CORPORATE COLLABORATION, Suwon-si (KR)

(21) Appl. No.: 12/713,243

(22) Filed: Feb. 26, 2010

(30) Foreign Application Priority Data
Feb. 10, 2010 (KR) 10-2010-0012508

(51) Int. Cl. G05B 23/02; G08B 9/00; G06F 7/00

(52) U.S. Cl. 340/3.1; 340/286.02; 340/5.8

(57) ABSTRACT

The present invention relates to a base station, a sensor network system including the base station, and a method of determining a security threshold for the sensor network system.

In the method of determining a security threshold for a sensor network system, the sensor network system includes a base station and a plurality of sensor nodes. The plurality of sensor nodes is deployed in an area of interest. Routing paths from the deployed sensor nodes to the base station are set. The base station receives information from the deployed sensor nodes. A security threshold is determined based on the received information. Accordingly, the present invention can minimize unnecessary energy consumption while maintaining a security level suitable for the current situation of a sensor network system.

### CROSS-REFERENCE TO RELATED APPLICATION

This application claims priority to and the benefit of Korean Patent Application No. 10-2010-0012508 filed in the Korean Intellectual Property Office on Feb. 10, 2010, the entire contents of which are incorporated herein by reference.

### BACKGROUND OF THE INVENTION

1. Field of the Invention

The present invention relates in general to a base station, a sensor network system including the base station, and a method of determining a security threshold for the sensor network system, and, more particularly, to a base station, a sensor network system including the base station, and a method of determining a security threshold for the sensor network system, which can determine a security threshold on the basis of information received from deployed sensor nodes.

2. Description of the Related Art

A sensor network system refers to a network system configured such that sensor nodes distributed to a three-dimensional space measure analog data such as sound, light and motion in three-dimensional space and forward the measured data to a central base station.

Generally, a plurality of sensor nodes converts analog data measured in a physical space into digital data and forwards the digital data to the base station.

The base station, having received the digital data from the plurality of sensor nodes, forwards the digital data to a user terminal over an external network or to a user terminal directly connected to the base station, and thus provides data about a sensed event or the like to a user.

In order to construct such a sensor network system, a user deploys sensor nodes in an area of interest from which information is desired to be obtained, and the deployed sensor nodes are arranged in an open environment, and thus the sensor nodes are vulnerable to physical attacks by an attacker. Further, an attacker may capture sensor nodes, obtain security information such as authentication keys, generate a false report including false information by using the obtained authentication keys, and then insert the false report into a sensor network system using a compromised node which has been captured by the attacker.

When such a false report is forwarded, false information may be provided to a user, and in addition, the lifespan of the sensor network may be shortened because unnecessary energy consumption occurs due to the forwarding of the false report.

However, it is impossible to prevent the physical capturing of sensor nodes due to the characteristics of the sensor network system in which the sensor nodes are deployed and operated in an open environment. Accordingly, it is very important to efficiently detect and eliminate a false report when the false report is generated.

Accordingly, there has been used a method in which a sensor node present in a routing path for an event report eliminates a false report using a statistical en-route filtering mechanism (hereinafter referred to as an “SEF mechanism”) when an event occurs.

According to the SEF mechanism, when any event occurs in the sensor network system in which sensor nodes assigned authentication keys are deployed, one of the sensor nodes which sense the event is determined to be a representative node (a Center of Stimulus [CoS] node). The CoS node receives both assigned authentication key indices and message authentication codes generated using authentication keys from other sensor nodes which sense the event, causes the received authentication key indices and message authentication codes to be included in an event report, and forwards the event report to the base station over multiple hops.

Each sensor node present in a routing path for the event report determines, using its own authentication key and the authentication key indices and the message authentication codes which are included in the event report, whether the event report is a false report, and then eliminates the false report when the event report is determined to be a false report.

In this case, according to the conventional SEF mechanism, the CoS node causes a number of message authentication codes, corresponding to a security threshold optionally set by a user, to be included in the event report.

When the security threshold is set to a high value, the probability of detecting a false report can increase, but there is a problem in that the number of message authentication codes included in an event report increases, so that the size of the event report increases, and thus energy consumption caused by the forwarding of the report increases.

In contrast, when the security threshold is set to a low value, the size of an event report decreases and energy consumption can decrease, but there is a problem in that the probability of detecting a false report decreases.

Furthermore, even if a suitable security threshold is set, a problem may occur in that when the environment of a sensor network system changes as in the case of the occurrence of troubles or energy exhaustion of sensor nodes, a preset security threshold becomes excessively high or low.

### SUMMARY OF THE INVENTION

Accordingly, the present invention has been made keeping in mind the above problems occurring in the prior art, and an object of the present invention is to provide a base station, a sensor network system including the base station, and a method of determining a security threshold for the sensor network system, which receive information deployed in an area of interest and determine a security threshold using a fuzzy logic on the basis of the received information, thus minimizing unnecessary energy consumption while maintaining a security level suitable for the current situation of a network.

Another object of the present invention is to provide a base station, a sensor network system including the base station, and a method of determining a security threshold for the sensor network system, which update a preset security threshold according to the changed environment when the environment of the sensor network system changes, thus flexibly coping with a change in a network environment.

In order to accomplish the above objects, the present invention provides a method of determining a security threshold for a sensor network system, the sensor network system including a base station and a plurality of sensor nodes, comprising deploying the plurality of sensor nodes in an area of interest; setting routing paths from the deployed sensor nodes to the base station; the base station receiving information from the deployed sensor nodes; and determining a security threshold based on the received information.

Preferably, the determining the security threshold may be configured such that the received information is classified as any one of a plurality of levels based on preset criteria, results of the classification are input to a preset fuzzy logic, and an output value from the fuzzy logic is determined to be the security threshold.

Preferably, the information may comprise at least one of density of the deployed sensor nodes, an average number of hops (hop count) corresponding to the set routing paths from the sensor nodes to the base station, and remaining energy of the sensor nodes.

Preferably, the determining the security threshold may be configured such that the received information is classified as any one of 45 levels obtained by combining three levels of the density of the sensor nodes, five levels of the average hop count, and three levels of the remaining energy, and an output value of the fuzzy logic corresponding to results of the classification is determined to be the security threshold.

Preferably, the method may further comprise monitoring whether information about the sensor nodes has changed; and updating the security threshold based on results of the monitoring.

Preferably, the method may further comprise propagating the security threshold to the plurality of deployed sensor nodes.

Preferably, the method may further comprise classifying the plurality of sensor nodes so that each of the sensor nodes is included in at least one partition; and assigning authentication keys, corresponding to a partition in which each of the sensor nodes is included, to the sensor node, wherein the deploying the sensor nodes is configured to deploy sensor nodes to which the authentication keys have been assigned.

Preferably, the method may further comprise, when any event occurs in the sensor network system, selecting a representative node (Center of Stimulus: CoS) from among sensor nodes which sense the event; the CoS node selecting a number of sensor nodes including the CoS node, to correspond to the security threshold, from among the sensor nodes which sense the event; and the CoS node generating an event report including authentication key indices and message authentication codes of the selected sensor nodes, and transmitting the generated event report to the base station via a multi-hop routing path.

Preferably, the method may further comprise an intermediate node present in the routing path verifying the event report; and dropping the event report when the event report is found to be a false report as a result of the verification.

Preferably, at the verifying the event report, the intermediate node may determine the event report to be the false report when at least one of the following conditions is satisfied, the conditions comprising a case where a number of message authentication codes included in the event report is not identical to the security threshold, a case where an authentication key index of an identical partition among the authentication key indices included in the event report is present in the intermediate node, and a case where when any of the authentication key indices of the event report is identical to an authentication key of the intermediate node, any of the message authentication codes of the event report is not identical to a message authentication code generated using the authentication key of the intermediate node.

Further, in order to accomplish the above objects, the present invention provides a base station for a sensor network system, comprising a communication unit for performing communication with sensor nodes deployed in a sensor network; a memory unit for storing a preset fuzzy logic; and a control unit for controlling the communication unit so that information is received from the deployed sensor nodes, classifying the received information as any one of a plurality of levels based on preset criteria, inputting results of the classification to the stored fuzzy logic, and determining an output value from the fuzzy logic to be a security threshold.

Preferably, the information may comprise at least one of density of the deployed sensor nodes, an average number of hops (hop count) corresponding to the set routing paths from the sensor nodes to the base station, and remaining energy of the sensor nodes.

Preferably, the memory unit may further store information classified as any one of 45 levels obtained by combining three levels of the density of the sensor nodes, five levels of the average hop count, and three levels of the remaining energy, and the control unit may determine an output value of the fuzzy logic corresponding to results of the classification to be the security threshold.

Preferably, the control unit may control the communication unit so as to monitor whether information about the sensor nodes has changed, and updates the security threshold based on results of the monitoring.

Preferably, the control unit may control the communication unit so that the security threshold is propagated to the plurality of deployed sensor nodes.

In addition, in order to accomplish the above objects, the present invention provides a sensor network system including a base station and a plurality of sensor nods deployed in an area of interest, wherein the base station sets a routing path from the deployed sensor nodes to the base station, receives information from the deployed sensor nodes, and determines a security threshold based on the received information.

Preferably, the base station may classify the received information as any one of a plurality of levels based on preset criteria, inputs results of the classification to a preset fuzzy logic, and determine an output value from the fuzzy logic to be the security threshold.

Preferably, the information may comprise at least one of density of the deployed sensor nodes, an average number of hops (hop count) corresponding to the set routing paths from the sensor nodes to the base station, and remaining energy of the sensor nodes.

Preferably, the base station may classify the received information as any one of 45 levels obtained by combining three levels of the density of the sensor nodes, five levels of the average hop count, and three levels of the remaining energy, and determine an output value of the fuzzy logic corresponding to results of the classification to be the security threshold.

Preferably, the base station may monitor whether information about the sensor nodes has changed, and update the security threshold based on results of the monitoring.

Preferably, the base station may propagate the security threshold to the plurality of deployed sensor nodes.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a sensor network system according to an embodiment of the present invention;

FIG. 2 is a diagram showing the construction of a base station according to an embodiment of the present invention;

FIG. 3 is a diagram showing the construction of a sensor node according to an embodiment of the present invention;

FIG. 4 is a diagram showing an example in which the sensor network system of the present invention forwards an event report;

FIG. 5 is a diagram showing an example in which the sensor network system of the present invention detects a false report;

FIG. 6 is a diagram showing an example in which the sensor network system of the present invention determines and propagates a security threshold;

FIGS. 7A to 7D are diagrams showing input/output functions of a fuzzy logic in the sensor network system of the present invention; and

FIG. 8 is a flowchart showing a process for determining a security threshold according to an embodiment of the present invention.

### DESCRIPTION OF THE PREFERRED EMBODIMENTS

Hereinafter, embodiments of the present invention will be described in detail with reference to the attached drawings.

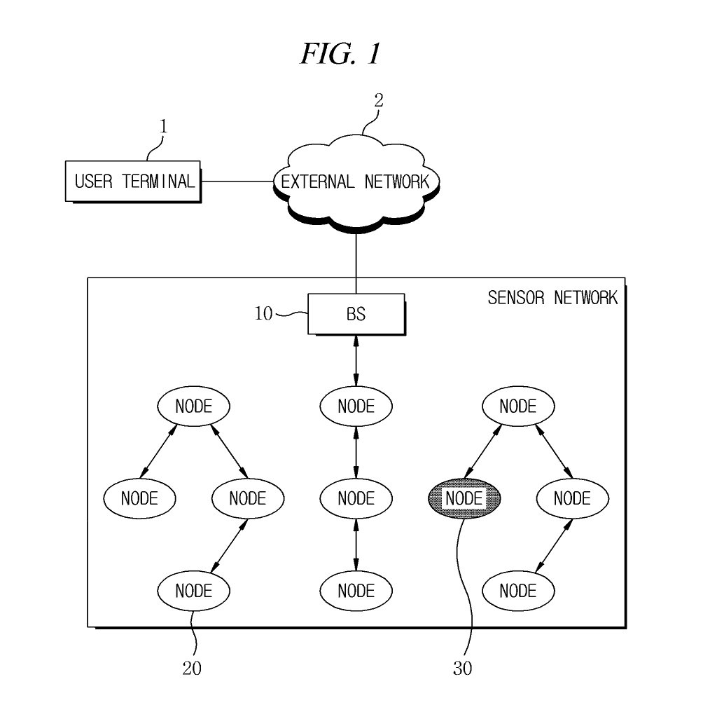

FIG. 1 is a diagram showing the construction of a sensor network system according to an embodiment of the present invention.

As shown in FIG. 1, a wireless sensor network system according to an embodiment of the present invention includes a Base Station (BS) 10 and a plurality of sensor nodes 20 deployed in an area of interest. Further, for the purpose of the extension of a network, clusters based on a clustering method may be constructed.

The BS 10 is connected to a user terminal 1 directly or via an external network 2 such as a Local Area Network (LAN), the Internet, a wireless network, for example, a Bluetooth network, or a communication network using an artificial satellite.

The user terminal 1 outputs and forwards information received from the sensor network system to a user via an application program or an application, and forwards a control command or data determined by the user on the basis of the received information to the base station 10.

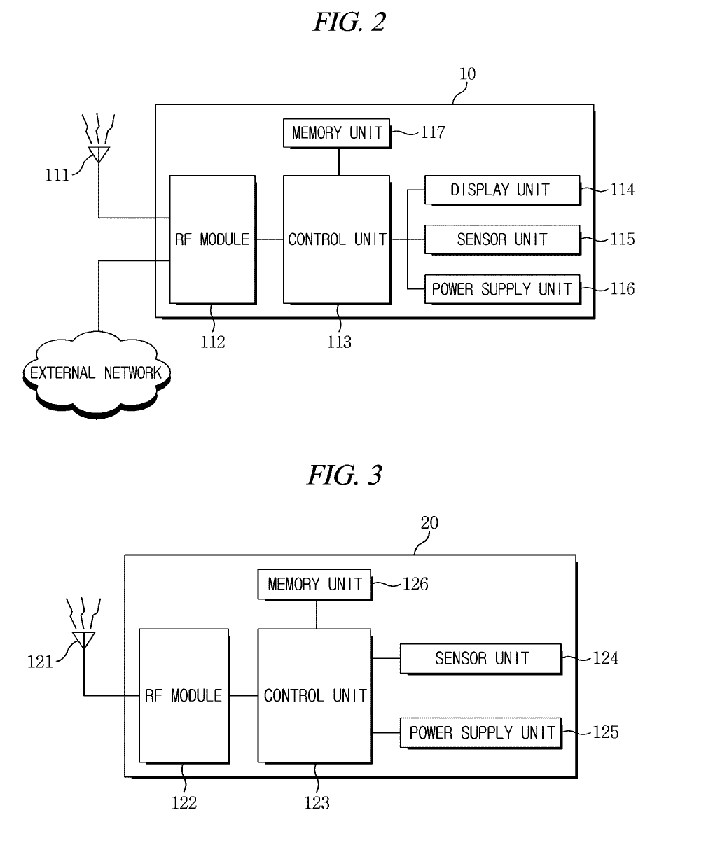

FIG. 2 is a diagram showing the construction of the base station according to an embodiment of the present invention. As shown in FIG. 2, the base station 10 may include an antenna 111, a communication unit (RF module) 112, a control unit 113, a display unit 114, a sensor unit 115, a power supply unit 116 and a memory unit 117.

The communication unit 112 performs data communication with sensor nodes 20 deployed in a sensor network and an external network through the antenna 111. The communication unit 112 may be implemented as a communication module for performing wireless network communication.

The display unit 114 outputs data acquired by the sensor network system, and the sensor unit 115 functions to sense a predetermined event and provide a warning when the event occurs.

The power supply unit 116 supplies power to individual components of the base station 10.

The memory unit 117 stores a fuzzy logic preset as input/output functions required for the determination of a security threshold.

The control unit 113 of the base station 10 controls the entire operation of the base station 10 or a sink node.

The control unit 113 of the base station 10 according to the present invention controls the communication unit 112 so that information is received from the sensor nodes 20 deployed in the sensor network, and classifies the received information as any one of a plurality of levels on the basis of preset criteria. Further, the control unit 113 inputs the results of the classification to the fuzzy logic stored in the memory unit 117, and then determines an output value from the fuzzy logic to be a security threshold for the sensor network system.

In this case, the received information may include at least one of the density of the sensor nodes deployed in the sensor network, the average number of hops (hop_count) from the deployed sensor nodes 20 to the base station 10, corresponding to routing paths set to range from the sensor nodes 20 to the base station 10, and the remaining energy of the deployed sensor node 20.

The determined security threshold is stored in the memory unit 117, and is propagated to the individual sensor nodes 20 through the communication unit 112.

The sensor network system eliminates a false report using a Statistical En-Route Filtering mechanism (hereinafter referred to as an “SEF mechanism”) according to the determined security threshold.

Meanwhile, the memory unit 117 of the base station 10 has a key pool which is a set of authentication keys (hereinafter also referred to as “keys”) required to determine whether a report is false. The key pool can be divided into n areas (hereinafter also referred to as “partitions”).

In this case, each of the partitions includes m keys and authentication key indices (or also called key indices or key IDs) corresponding to the keys. Here, “n” and “m” are any integers and can be optionally determined by the manager of the sensor network system or the like.

Each of the sensor nodes 20 is assigned any one of the n partitions included in the key pool before being deployed in the sensor network. The partition assigned to one sensor node 20 includes m authentication keys and key indices, and the m authentication keys are assigned to individual partitions so that they do not overlap one another.

In detail, each of the plurality of sensor nodes 20 deployed in the sensor network system is assigned k keys and key indices corresponding thereto, where k is any integer less than m. That is, each of the sensor nodes 20 is assigned any one of n partitions, and is assigned some (k) of m keys belonging to the assigned partition.

In this way, the sensor network system according to the present invention assigns some of the keys of the partition assigned to a specific sensor node 20, so that, even if the specific node is compromised by an attacker, all keys of the relevant partition are not leaked, thus minimizing damage.

The sensor nodes 20 to which the authentication keys have been assigned are deployed in the area of interest of the sensor network system.

FIG. 3 is a diagram showing the construction of the sensor node according to an embodiment of the present invention.

As shown in FIG. 3, the sensor node 20 includes an antenna 121, a communication unit (RF module) 122, a control unit 123, a sensor unit 124, a power supply unit 125, and a memory unit 126.

The communication unit 122 may perform various types of wireless communication according to the transmission/reception type, the frequency and the function thereof. In this case, the communication unit 122 may include a Radio Frequency (RF) module for performing RF communication based on IEEE 802.15.4-2006 standards and ZigBee standards.

The sensor unit 124 is a component for detecting information from the phenomenon of a physical system or an environmental system instead of the five senses of a human being, and includes a sensor for sensing an event. Depending on various application fields of the sensor network, various types of sensors can be used, and those sensors can sense information such as illuminance, heat, humidity, acceleration/seismic intensity, sound, earth magnetism, and location.

The power supply unit 125 supplies power to the components of the sensor node 20.

The memory unit 126 stores authentication keys assigned in advance before the sensor node 20 is deployed, a Message Authentication Code (MAC) generated using the authentication keys, and a security threshold received from the base station 10 after the sensor node 20 has been deployed.

The control unit 123 controls the entire operation of the sensor node 20 such as the processing of data acquired from the sensor unit 124.

The sensor node 20 has limited energy resources, a limited wireless communication range, limited memory capacity, and limited computational ability. The sensor node 20 having this construction is randomly deployed in the area of interest in the sensor network system.

When any event occurs in the sensor network, each of sensor nodes 20 which sense the event forwards an event report (hereinafter also referred to as a “report”) including data related to the event (the type of event that has occurred, and the time and place of occurrence of the event) to the base station 10. The reports forwarded to the base station 10 are transmitted to the user terminal 1, thus allowing the user to acquire information included in the sensor network.

The sensor nodes 20 are operated without requiring separate control by the user in the environment requiring unmanned monitoring as in the case of a battlefield, and thus can very conveniently and efficiently observe any place. However, the following problems must be considered in that the sensor network is configured in an open and unmanned environment such as a natural environment or a battlefield.

Since the sensor nodes 20 are randomly deployed in an unmanned environment, they have physical vulnerability. That is, an invader can physically compromise the sensor nodes 20.

A sensor node compromised by the invader in this way is called a compromised node 30. In FIG. 1, the compromised node 30 is marked as a shaded circle so that it can be distinguished from normal sensor nodes.

The invader can acquire information stored in the compromised node 30. In particular, the invader can acquire authentication keys related to the security of the sensor network from the compromised node 30. The invader generates a false report (that is, a fabricated report) using the acquired authentication keys, and injects the false report into the sensor network via the compromised node 30, thus leading the nodes and the manager of the sensor network into confusion.

In the present invention, an SEF mechanism can be used to solve the problems occurring due to the false report generated by the invader, as described above. The false report is transmitted from the compromised node 30 to the base station 10. The SEF mechanism allows sensor nodes present in a path for the false report, that is, intermediate nodes 25 and 27, to verify a relevant report and to eliminate, that is, drop, a false report when the relevant report is determined to be the false report.

In the SEF mechanism of the present invention, it is assumed that the number of partitions compromised by an invader (or an attacker) is less than the security threshold.

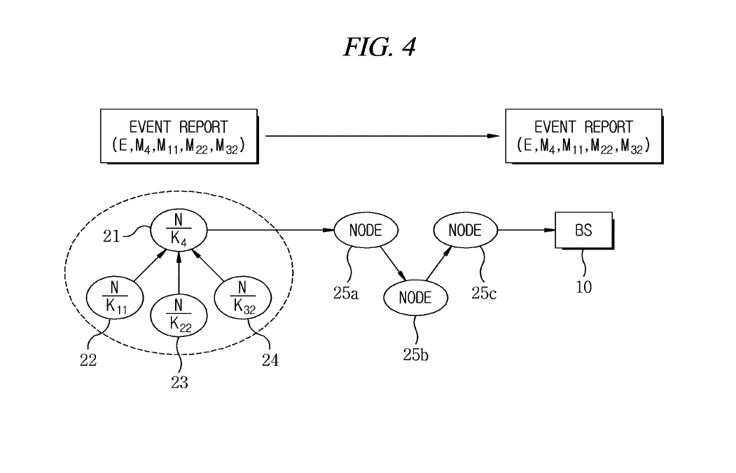

FIG. 4 is a diagram showing an example in which the sensor network system of the present invention forwards an event report.

When an event (also called a “case”) occurs after the sensor nodes 20 have been deployed, a node having the highest event sensing intensity is selected as a representative node (Center of Stimulus: CoS) 21 from among one or more sensor nodes 21, 22, 23 and 24 which sense the event, as shown in FIG. 4.

The CoS node 21 collects Message Authentication Codes (MACs) from neighboring nodes 22, 23 and 24 which sense the event. Each of the neighboring nodes 22, 23 and 24 generates a MAC using event information (the type of event, the time and place of occurrence of the event, etc.) and some or all of the authentication keys assigned thereto.

The CoS node 21 receives event information and MACs from the neighboring nodes 22, 23 and 24, and generates an event report by combining the event information with the MACs.

In detail, the CoS node 21 causes a number of MACs, corresponding to the security threshold determined using the fuzzy logic, to be included in the event report and forwards the event report to the base station 10 over multiple hops. In this case, the CoS node 21 may optionally select pairs of authentication key indices and MACs which are generated using authentication keys of different partitions so that the pairs correspond to the security threshold, and may cause the selected pairs to be included in the event report.

For example, when the security threshold is 4, the event report may include three authentication key indices K₁₁, K₂₂ and K₃₂ and message authentication codes M₁₁, M₂₂ and M₃₂ which are received from the three neighboring nodes 22, 23 and 24, together with the authentication key index K₄ and the MAC M₄ of the CoS node 21, as shown in FIG. 4. Accordingly, a total of four MACs M₄, Mₙ, M₂₂ and M₃₂ corresponding to the security threshold are included in the event report. In this case, the CoS node 21 and the three selected neighboring nodes 22, 23 and 24 can belong to different partitions of the key pool.

In a path from the CoS node 21 to the base station 10, sensor nodes 25a, 25b and 25c which relay the event report will be present. Such sensor nodes are designated as intermediate nodes 25a, 25b and 25c.

The intermediate nodes 25a, 25b and 25c verify the received event report, and then replay the event report to the base station 10.

When a report is forwarded from the CoS node 21 to the base station 10, the intermediate nodes 25a, 25b and 25c present in respective paths verify the report, and then detect a false report.

The intermediate nodes 25a, 25b and 25c determine whether the number of pairs of authentication key indices and MACs included in the event report (or the number of MACs: MAC length) is identical to the security threshold. When the number of MACs is not identical to the security threshold, the event report is dropped as a false report.

The intermediate nodes 25a, 25b and 25c determine whether authentication key indices included in the report are composed of authentication keys belonging to different partitions. When a plurality of authentication keys belonging to the same partition is present in the event report, the event report is dropped as a false report.

The intermediate nodes 25a, 25b and 25c compare key indices corresponding to the MACs included in the event report with their own key indices.

When key indices identical to their own key indices are not included in the event report, the intermediate nodes 25a, 25b and 25c cannot verify the event report, and route the event report to the base station 10.

When key indices identical to their own key indices are included in the event report, the intermediate nodes 25a, 25b and 25c personally generate MACs using their own key indices, and compare the generated MACs with the MACs included in the event report.

In this case, when the MACs generated by the intermediate nodes 25a, 25b and 25c using their own key indices are identical to MACs included in the event report, the intermediate nodes determine the event report to be a normal report, and relay the event report to the base station 10.

In contrast, when the MACs generated by the intermediate nodes 25a, 25b and 25c using their own key indices are different from the MACs included in the event report, the intermediate nodes determine the event report to be a false report, and eliminate, that is, drop, the false report.

Using the above technique, before the false report reaches the base station 10, it can be dropped early by the intermediate nodes 25a, 25b and 25c. As a result, energy consumption required for the verification and forwarding of the false report between the sensor nodes 20 and the base station 10 can be reduced.

If the false report is transmitted to the base station 10 via all of the intermediate nodes 25a, 25b and 25c without being dropped, the base station 10 verifies the finally received false report using MACs. In this case, since the base station 10 has all authentication keys assigned to the sensor network, the false report which was not detected during a report forwarding process can be ultimately detected by the base station 10.

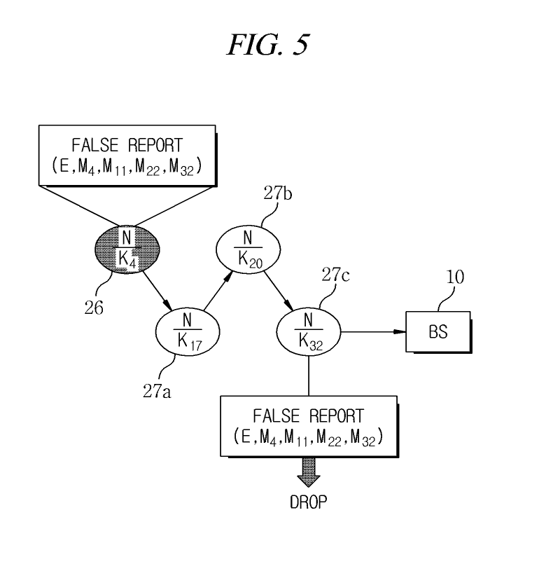

FIG. 5 is a diagram showing an example in which the sensor network system of the present invention detects a false report.

In FIG. 5, a sensor node 26 is assumed to be a compromised node captured by an invader.

The invader can control the compromised node 26 so that it generates a false report indicating that an event has occurred. The compromised node 26 generates a Message Authentication Code (MAC) M₄ using an authentication key index K₄ stored therein. In this case, a MAC M₁ corresponds to a code generated using a normal key.

The compromised node 26 inserts compromised MACs M₁₁, M₂₂ and M₃₂ into a false report and routes the false report to the base station 10. In this case, since the compromised node 26 does not know even the authentication key indices of normal sensor nodes, the MACs M₁₁, M₂₂ and M₃₂ correspond to false codes.

The false report is selectively verified by intermediate nodes 27a, 27b and 27c while being relayed to the base station 10.

Since the intermediate node 27a does not store a key index identical to any of the key indices present in the false report, it does not verify the false report and routes the false report to the next intermediate node 27b.

Since the intermediate node 27b does not store a key index identical to any of the key indices present in the false report, it does not verify the false report and routes the false report to the next intermediate node 27c.

Since the intermediate node 27c includes a key index K₃₂, it generates a MAC using its own key index K₃₂, and compares the generated MAC with the MAC M₃₂ present in the false report, thus verifying the false report.

In this case, when the MACs are found to be different from each other by the MAC comparison procedure, the intermediate node 27c determines the received report to be the false report, as shown in FIG. 5, and drops the false report without relaying the false report to the base station 10.

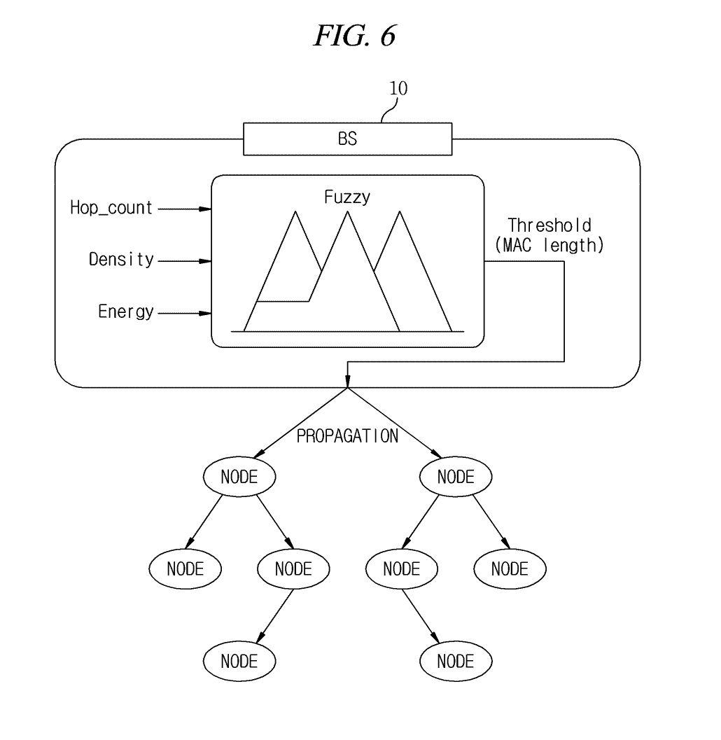

FIG. 6 is a diagram showing an example in which the sensor network system of the present invention determines and propagates a security threshold.

The base station 10 of the present invention has sufficient computational ability and energy, is safe from an attack by an attacker, and is capable of computing the density of the sensor network, the average number of hops (hop_count) by which an event report is forwarded, and the remaining energy levels of sensor nodes 20 when the sensor network system is constructed.

In this case, the density of the deployed sensor nodes 20 can vary with the passage of time, and routing paths (or forwarding paths) from the sensor nodes 20 to the base station 10 is set in advance when the sensor node 20 is deployed.

As shown in FIG. 6, the base station 10 receives information from a plurality of sensor nodes deployed in a sensor network after authentication keys have been assigned, classifies the received information as one of a plurality of levels on the basis of preset criteria, inputs the results of the classification to a preset fuzzy logic, and determines an output value from the fuzzy logic to be a security threshold.

The determined security threshold corresponds to the number of message authentication codes (MAC length) of the neighboring nodes 22, 23 and 24 which are included in an event report generated by the CoS node 21 when an event occurs.

The information received from the plurality of sensor nodes 20 is the environmental information of the sensor network system, and includes at least one of the density of deployed sensor nodes 20, the average number of hops (hop_count) corresponding to the set routing paths from the sensor nodes 20 to the base station 10, and the remaining energy of the sensor nodes 20.

The base station 10 propagates the security threshold determined based on the received environmental information to individual sensor nodes 20 of the sensor network. In this case, the base station 10 can propagate the security threshold to all of the sensor nodes 20 using a broadcasting signal.

All of the sensor nodes 20 having received the security threshold from the base station 10 have the same security threshold. The base station 10 can periodically monitor whether the above environmental information has changed.

As a result of the monitoring, when a change in the environmental information such as the troubles or energy exhaustion of some nodes 20 has been sensed, the base station updates the existing security threshold to an optimal security threshold suitable for the current situation of the network. The updated security threshold is propagated to the individual sensor nodes of the network using a broadcasting signal.

Accordingly, the sensor network system of the present invention can more flexibly cope with various changes in the network operating in an open environment.

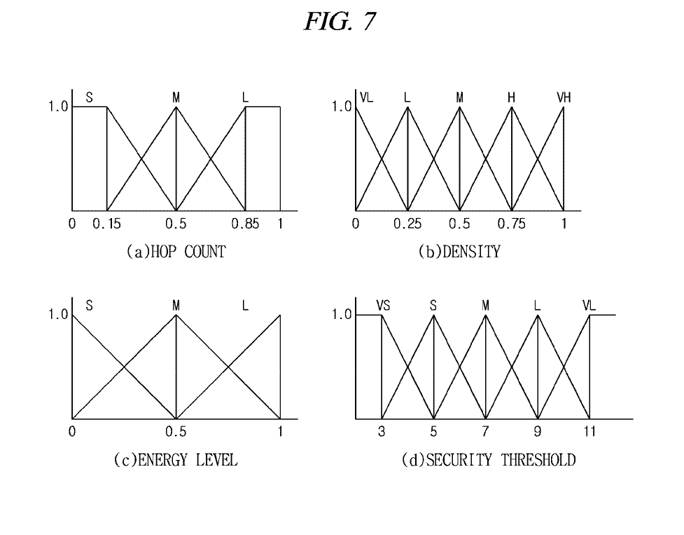

FIGS. 7A to 7D are diagrams showing input/output functions of a fuzzy logic in the sensor network system of the present invention.

The present invention uses a fuzzy logic to determine a security threshold suitable for the status of the network. The input value of the fuzzy logic is information about each deployed sensor node 20, and includes at least one of average hop_count by which an event report is forwarded, the density of the sensor nodes 20, and the remaining energy of the sensor nodes 20.

As shown in FIG. 7A, the average hop_count is classified into three levels, that is, S (small), M (medium) and L (large). As shown in FIG. 7B, density is classified into five levels, that is, VL (very low), L (low), M (medium), H (high) and VH (very high). As shown in FIG. 7C, energy is classified into three levels, that is, S (small), M (medium) and L (large).

As shown in FIG. 7D, the security threshold which is the output value of the fuzzy logic is classified into five levels, that is, VS (very small), S (small), M (medium), L (large), and VL (very large).

The classification levels of pieces of information and the levels of the determined security threshold are represented by the following formulas.

Hop_count={SMALL, MEDIUM, LARGE}

Density={VERY_SMALL, SMALL, MEDIUM, LARGE, VERY_LARGE}

Energy={SMALL, MEDIUM, LARGE}

Threshold={VERY_SMALL, SMALL, MEDIUM, LARGE, VERY_LARGE}

Individual input functions and output functions are determined by the following rules of the fuzzy logic (hereinafter referred to as “IF-THEN rules”).

For example, from the standpoint of energy consumption, it is profitable to determine the security threshold to be small and thus to reduce an overhead attributable to the transmission of a report when the size of the network is small and the average hop_count by which the report must be moved is small, whereas it is profitable to determine the security threshold to be large, and thus to prevent an increase in an overhead attributable to the transmission of a report and promptly discover a false report when the average hop_count is large in the network. The density of the nodes 20 is used to determine the upper limit of the security threshold. Even in the case of a network having large hop_count, when the density of the network is low, the number of nodes capable of sensing an event is small, and thus the security threshold cannot be determined to be higher than the density.

In the present invention, in consideration of these characteristics, IF-THEN rules can be determined. The fuzzy IF-THEN rules applied to the present invention are configured such that the input value of the fuzzy logic is classified as one of 45 levels obtained by combining the levels of FIGS. 7A, 7B and 7C, and the output value of the fuzzy logic corresponding to the results of the classification is determined to be the security threshold. Some of the determined rules of the fuzzy logic are given as follows.

RULE 8: IF (Hop_count IS SMALL) AND (Density IS VERY_SMALL) AND (Energy IS SMALL) THEN (Threshold IS VERY_SMALL)

RULE 13: IF (Hop_count IS MEDIUM) AND (Density IS SMALL) AND (Energy IS MEDIUM) THEN (Threshold IS SMALL)

RULE 19: IF (Hop_count IS LARGE) AND (Density IS MEDIUM) AND (Energy IS MEDIUM) THEN (Threshold IS MEDIUM)

RULE 39: IF (Hop_count IS MEDIUM) AND (Density IS VERY_LARGE) AND (Energy IS LARGE) THEN (Threshold IS LARGE)

The base station 10 according to an embodiment of the present invention stores 45 rules of the fuzzy logic stored in the memory unit 117 to correspond to 45 levels based on the combination of one or more pieces of environmental information of the nodes 20 received by the sensor network system, and can determine the output value of the fuzzy logic corresponding to the level of the received environmental information to be the security threshold.

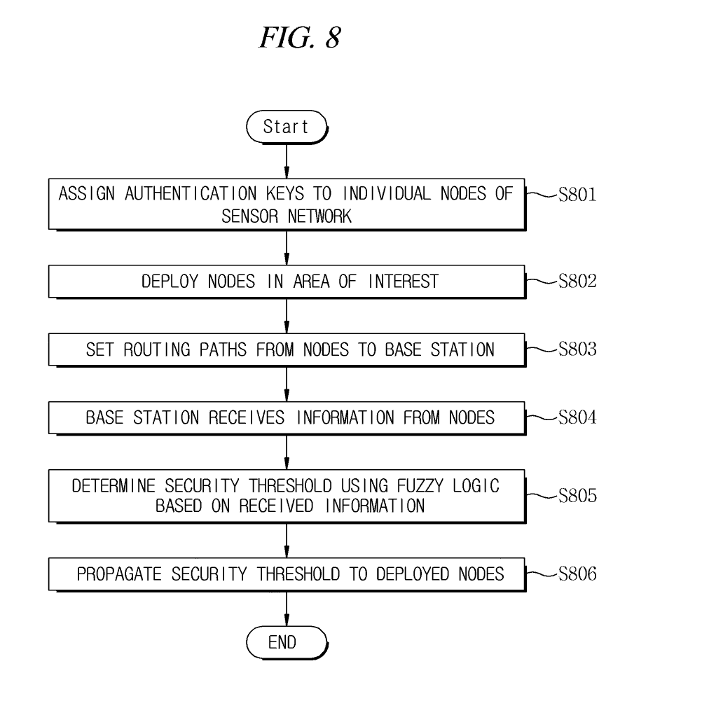

FIG. 8 is a flowchart showing a process for determining a security threshold according to an embodiment of the present invention.

As shown in FIG. 8, the base station 10 can assign authentication keys to individual nodes 20 of the sensor network at step S801. In this case, the base station 10 assigns authentication keys before the nodes 20 are deployed, divides the plurality of nodes 20 into at least one partition, and is capable of assigning different authentication keys to respective partitions.

At step S802, the sensor nodes 20 to which the authentication keys have been assigned at step S801 are randomly deployed in the area of interest in the sensor network system.

At step S803, the base station 10 sets routing paths from the sensor nodes 20 deployed at step S802 to the base station 10.

At step S804, the base station 10 receives information from the individual nodes 20 which have been deployed at step S802. The received information may include at least one of the density of the deployed sensor nodes 20, the average hop_count corresponding to the routing paths, set at step S803, from the sensor nodes 20 to the base station 10, and the remaining energy of the sensor nodes 20.

At step S805, the base station 10 determines a security threshold using a fuzzy logic on the basis of the information received at step S804. In this case, the rules of the fuzzy logic applied to step S805 may be implemented using the rules shown in FIGS. 7A to 7D and described with reference to the drawings.

At step S806, the base station 10 propagates the security threshold, determined at step S805, to the nodes 20 deployed at step S802. In this case, the base station 10 can propagate the security threshold using a broadcasting signal.

Thereafter, when each of the sensor nodes 20 senses the occurrence of any event, it generates a MAC using the authentication keys assigned at step S801.

Further, a CoS node 21 is selected from among sensor nodes 20 which sense the event. The CoS node 21 selects a number of neighboring nodes 22, 23 and 24 together with the CoS node 21, to correspond to the security threshold determined at step S805, and receives authentication key indices and MACs from the selected neighboring nodes 22, 23 and 24.

The CoS node 21 generates an event report including its own authentication key index and MAC and the authentication key indices and the MACs received from the selected neighboring nodes 22, 23 and 24, and forwards the event report to the base station 10 over multiple hops.

Intermediate nodes 25 and 27 present in a routing path for the event report verify the event report and drop the event report when the event report is a false report, as described above with reference to FIGS. 4 and 5.

As described above, a base station, a sensor network system including the base station, and a method of determining a security threshold for the sensor network system according to the present invention are advantageous in that information deployed in an area of interest is received, and a security threshold is determined using a fuzzy logic on the basis of the received information, thus minimizing unnecessary energy consumption while maintaining a security level suitable for the current situation of a network.

Further, the present invention is advantageous in that, even in a sensor network system having low density, an event report is normally generated and is applied to various types of network environments, and unnecessary energy consumption is minimized, thus increasing the lifespan of the entire sensor network system.

Furthermore, the present invention is advantageous in that when the environment of a sensor network system changes, a preset security threshold is updated according to the changed environment, thus flexibly coping with a change in a network environment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of determining a security threshold for a sensor network system, the sensor network system including a base station and a plurality of sensor nodes, comprising:
deploying the plurality of sensor nodes in an area of interest;
setting routing paths from the deployed sensor nodes to the base station;
the base station receiving information from the deployed sensor nodes; and
determining a security threshold based on the received information.

2. The method according to claim 1, wherein the determining the security threshold is configured such that the received information is classified as any one of a plurality of levels based on preset criteria, results of the classification are input to a preset fuzzy logic, and an output value from the fuzzy logic is determined to be the security threshold.

3. The method according to claim 2, wherein the information comprises at least one of density of the deployed sensor nodes, an average number of hops (hop count) corresponding to the set routing paths from the sensor nodes to the base station, and remaining energy of the sensor nodes.

4. The method according to claim 3, wherein the determining the security threshold is configured such that the received information is classified as any one of 45 levels obtained by combining three levels of the density of the sensor nodes, five levels of the average hop count, and three levels of the remaining energy, and an output value of the fuzzy logic corresponding to results of the classification is determined to be the security threshold.

5. The method according to claim 1, further comprising:
monitoring whether information about the sensor nodes has changed; and
updating the security threshold based on results of the monitoring.

6. The method according to claim 5, further comprising propagating the security threshold to the plurality of deployed sensor nodes.

7. The method according to claim 1, further comprising:
classifying the plurality of sensor nodes so that each of the sensor nodes is included in at least one partition; and
assigning authentication keys, corresponding to a partition in which each of the sensor nodes is included, to the sensor node,
wherein the deploying the sensor nodes is configured to deploy sensor nodes to which the authentication keys have been assigned.

8. The method according to claim 7, further comprising:
when any event occurs in the sensor network system, selecting a representative node (Center of Stimulus: CoS) from among sensor nodes which sense the event;
the CoS node selecting a number of sensor nodes including the CoS node, to correspond to the security threshold, from among the sensor nodes which sense the event; and
the CoS node generating an event report including authentication key indices and message authentication codes of the selected sensor nodes, and transmitting the generated event report to the base station via a multi-hop routing path.

9. The method according to claim 8, further comprising:
an intermediate node present in the routing path verifying the event report; and
dropping the event report when the event report is found to be a false report as a result of the verification.

10. The method according to claim 9, wherein at the verifying the event report, the intermediate node determines the event report to be the false report when at least one of the following conditions is satisfied, the conditions comprising a case where a number of message authentication codes included in the event report is not identical to the security threshold, a case where an authentication key index of an identical partition among the authentication key indices included in the event report is present in the intermediate node, and a case where when any of the authentication key indices of the event report is identical to an authentication key of the intermediate node, any of the message authentication codes of the event report is not identical to a message authentication code generated using the authentication key of the intermediate node.

11. A base station for a sensor network system, comprising:
a communication unit for performing communication with sensor nodes deployed in a sensor network;
a memory unit for storing a preset fuzzy logic; and
a control unit for controlling the communication unit so that information is received from the deployed sensor nodes, classifying the received information as any one of a plurality of levels based on preset criteria, inputting results of the classification to the stored fuzzy logic, and determining an output value from the fuzzy logic to be a security threshold.

12. The base station according to claim 11, wherein the information comprises at least one of density of the deployed sensor nodes, an average number of hops (hop count) corresponding to the set routing paths from the sensor nodes to the base station, and remaining energy of the sensor nodes.

13. The base station according to claim 12, wherein:
the memory unit further stores information classified as any one of 45 levels obtained by combining three levels of the density of the sensor nodes, five levels of the average hop count, and three levels of the remaining energy, and
the control unit determines an output value of the fuzzy logic corresponding to results of the classification to be the security threshold.

14. The base station according to claim 11, wherein the control unit controls the communication unit so as to monitor whether information about the sensor nodes has changed, and updates the security threshold based on results of the monitoring.

15. The base station according to claim 14, wherein the control unit controls the communication unit so that the security threshold is propagated to the plurality of deployed sensor nodes.

16. A sensor network system including a base station and a plurality of sensor nods deployed in an area of interest, wherein:
the base station sets a routing path from the deployed sensor nodes to the base station, receives information from the deployed sensor nodes, and determines a security threshold based on the received information.

17. The sensor network system according to claim 16, wherein the base station classifies the received information as any one of a plurality of levels based on preset criteria, inputs results of the classification to a preset fuzzy logic, and determines an output value from the fuzzy logic to be the security threshold.

18. The sensor network system according to claim 17, wherein the information comprises at least one of density of the deployed sensor nodes, an average number of hops (hop count) corresponding to the set routing paths from the sensor nodes to the base station, and remaining energy of the sensor nodes.

19. The sensor network system according to claim 18, wherein the base station classifies the received information as any one of 45 levels obtained by combining three levels of the density of the sensor nodes, five levels of the average hop count, and three levels of the remaining energy, and determines an output value of the fuzzy logic corresponding to results of the classification to be the security threshold.

20. The sensor network system according to claim 16, wherein the base station monitors whether information about the sensor nodes has changed, and updates the security threshold based on results of the monitoring.

21. The sensor network system according to claim 20, wherein the base station propagates the security threshold to the plurality of deployed sensor nodes.
